(19) United States
(12) Patent Application Publication
(10) Pub. No.: US 2020/0111471 A1
(43) Pub. Date: Apr. 9, 2020

(54) SYSTEM FOR CONTROLLING NOISE OF VEHICLE AND METHOD THEREOF

(71) Applicants: Hyundai Motor Company, Seoul (KR); Kia Motors Corporation, Seoul (KR)

(72) Inventors: In Soo JUNG, Suwon-si (KR); Dongchul LEE, Anyang-si (KR)

(73) Assignees: Hyundai Motor Company, Seoul (KR); Kia Motors Corporation, Seoul (KR)

(21) Appl. No.: 16/417,331

(22) Filed: May 20, 2019

(30) Foreign Application Priority Data
Oct. 8, 2018 (KR) 10-2018-0119892

(51) Int. Cl. G10K 11/178; B60R 11/02

(52) U.S. Cl. CPC G10K 11/17823; B60R 2011/0038; B60R 11/0247

(57) ABSTRACT

A system for controlling noise of a vehicle includes: an engine speed sensor configured for detecting a speed of an engine of the vehicle; a microphone detecting noise of the vehicle; an engine state sensor configured for detecting an operating state of the engine; a signal processing controller receiving the speed of the engine, the noise of the vehicle, and the engine operating state and generating amplified noise based on at least one of the received engine speed, the received noise of the vehicle, and the received engine operating state; a signal processing amplifier receiving the engine speed and the amplified noise and generating output noise by amplifying the amplified noise as much as amplification degree based on the speed of the engine; and a sound transmitting device receiving the output noise and transmitting the output noise or a separate sound source corresponding to the output noise to the vehicle.

### CROSS-REFERENCE TO RELATED APPLICATION

The present application claims priority to Korean Patent Application No. 10-2018-0119892 filed on Oct. 8, 2018, the entire contents of which is incorporated herein for all purposes by this reference.

### BACKGROUND OF THE INVENTION

### Field of the Invention

The present invention relates to a system for controlling noise of a vehicle, more particularly, to a system for controlling noise of a vehicle configured for controlling noise of the vehicle based on an operating state of an engine such as vibration of the engine or a combustion pressure of the engine and a driving state of the vehicle such as an opening amount of a throttle valve.

### Description of Related Art

In general, a study on noise of a vehicle may be classified as studying how to reduce noise from a noise source, how to cancel noise using a sound absorbing material, and how to cancel noise using active noise control (ANC). The ANC is a technique for reducing vehicle noise, and controls the noise of booming bandwidth having a frequency of 250 Hz or less using a sound source with a phase opposite to that of the noise.

The ANC minimalizes noise of the vehicle. When a noise is generated, the ANC emits a sound wave having an inverted phase to the noise through an audio device, canceling the noise.

The method of using the sound absorbing material is effective with respect to a high frequency noise higher than 500 Hz. However, in the case of a low frequency noise, the size of the sound absorbing material needs to be increased, which results in increased cost. Accordingly, when weight reduction is desirable, such as for an aircraft or a vehicle, the method may not be suitable.

As environmental problems have become serious recently, there is an increasing demand for a vehicle that consumes less fuel to reduce an amount of exhaust gas. As a solution to the present problem, research is underway to reduce a weight of the vehicle and increase efficiency of an engine. This solution inevitably affects the noise and vibration of the vehicle badly.

Therefore, the ANC has been developed recently. However, the ANC is merely to reduce internal noise of a vehicle. The ANC does not reflect needs of a driver of the vehicle with respect to dynamic engine noise.

As a technique to compensate for this, there is an active sound design (ASD) technology. The ASD technology is designed to reflect the needs of the driver by pre-recording virtual sound sources, such as advanced vehicle internal noise, and reproducing the sound sources through an internal speaker while the vehicle is driven.

However, the ANC and the ASD use a microphone to detect noise and use a speaker to generate a separate noise (i.e., noise by a control signal or a pre-recorded virtual sound source) to correspond to the noise. Thus, these technologies have a problem in that the speaker control is delayed and thus the driver may feel difference or delay.

Furthermore, location or origin of engine noise from an engine compartment and location of the separate noise generated through the speaker are different from each other. The speaker is mounted in the vehicle internal for the ANC and the ASD. Thus, the driver may again feel the difference.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a system for controlling noise of a vehicle and a method thereof configured for removing unnecessary noise and reinforcing necessary noise among noise occurring in an engine by detecting an operating state of the engine, a driving state of the vehicle, internal noise of the vehicle, and the engine speed.

An exemplary embodiment of the present invention may provide the system for controlling the noise of the vehicle, including: an engine speed sensor configured to detect a speed of an engine of the vehicle; a microphone configured to detect noise of the vehicle; an engine state sensor configured to detect an operating state of the engine; a signal processing controller connected to the engine speed sensor, the microphone and the engine state sensor and configured to receive the speed of the engine from the engine speed sensor, the noise of the vehicle from the microphone, and the engine operating state from the engine state sensor and to generate amplified noise based on at least one of the received engine speed, the received noise of the vehicle, and the received engine operating state; a signal processing amplifier connected to the engine speed sensor and the signal processing controller and configured to receive the speed of the engine from the engine speed sensor and the amplified noise from the signal processing controller and to generate output noise by amplifying the amplified noise as much as amplification degree based on the speed of the engine; and a sound transmitting device connected to the signal processing amplifier and configured to receive the output noise and transmit the output noise or a separate sound source corresponding to the output noise to the vehicle.

The microphone may be disposed in at least one of inside of an engine compartment of the vehicle, internal to the vehicle, and outside of the vehicle.

The sound transmitting device may be disposed in at least one of inside of an engine compartment of the vehicle, internal to the vehicle, and outside of the vehicle.

The amplified noise may include at least one of reinforced noise and reduced noise. The signal processing controller may be configured to generate the reinforced noise based on at least one of the speed of the engine and the operating state of the engine.

The signal processing controller may be configured to generate the reduced noise based on at least one of the noise of the vehicle received from the microphone and an engine order component corresponding to a frequency characteristic of the engine.

The system for controlling the noise of the vehicle may further include: a pedal opening sensor configured to detect a pedal opening state of the vehicle and transmit the pedal opening state to the signal processing amplifier. The signal processing amplifier may be configured to set the amplification degree based on the pedal opening state received from the pedal opening sensor.

The system for controlling the noise of the vehicle may further include: a driving mode sensor configured to detect a driving mode of the vehicle and transmit the driving mode to the signal processing amplifier. The signal processing amplifier may be configured to set the amplification degree based on the driving mode.

The system for controlling the noise of the vehicle may further include: a vehicle speed sensor configured to detect a speed of the vehicle and transmit the speed of the vehicle to the signal processing amplifier. The signal processing amplifier may be configured to set the amplification degree based on the speed of the vehicle.

The system for controlling the noise of the vehicle may further include: a sound storage device connected to the signal processing amplifier and the sound transmitting device and configured to receive the output noise and determine the separate sound source corresponding to the output noise to transmit the separate sound source to the sound transmitting device.

The sound storage device may be configured to determine the sound source corresponding to the output noise based on predetermined mapping data to transmit the sound source to the sound transmitting device.

An exemplary embodiment of the present invention may provide the method for controlling the noise of the vehicle including an engine speed sensor, a microphone, an engine state sensor, a signal processing controller, a signal processing amplifier, and a sound transmitting device, including: detecting, by the engine speed sensor, a speed of an engine of the vehicle; detecting, by the microphone, noise of the vehicle; detecting, by the engine state sensor, an operating state of the engine; receiving, by the signal processing controller, the speed of the engine from the engine speed sensor, the noise of the vehicle from the microphone, and the engine operating state from the engine state sensor to generate amplified noise based on at least one of the received engine speed, the received noise of the vehicle, and the received engine operating state; receiving, by the signal processing amplifier, the speed of the engine from the engine speed sensor and the amplified noise from the signal processing controller to generate output noise by amplifying the amplified noise as much as amplification degree based on the speed of the engine; and receiving, by the sound transmitting device, the output noise from the signal processing amplifier so that the sound transmitting device transmits the output noise to the vehicle.

The noise of the vehicle may be detected in at least one of inside of an engine compartment of the vehicle, internal to the vehicle, and outside of the vehicle. The output noise may be transmitted to at least one of an engine compartment of the vehicle, internal to the vehicle, and outside of the vehicle.

The amplified noise may include at least one of reinforced noise and reduced noise. The reinforced noise may be generated based on at least one of the speed of the engine and the operating state of the engine.

The reduced noise may be generated based on at least one of the noise of the vehicle received from the microphone and an engine order component corresponding to a frequency characteristic of the engine.

The vehicle may further include a pedal opening sensor configured to detect a pedal opening state of the vehicle, and transmit the pedal opening state to the signal processing amplifier. The signal processing amplifier may be configured to set the amplification degree based on the pedal opening state received from the pedal opening sensor.

The vehicle may further include a driving mode sensor configured to detect a driving mode of the vehicle and transmit the driving mode to the signal processing amplifier. The signal processing amplifier may be configured to set the amplification degree based on the driving mode.

The vehicle may further include a vehicle speed sensor configured to detect a speed of the vehicle and transmit the speed of the vehicle to the signal processing amplifier. The signal processing amplifier may be configured to set the amplification degree based on the speed of the vehicle.

Another exemplary embodiment of the present invention may provide the method for controlling the noise of the vehicle including an engine speed sensor, a microphone, an engine state sensor, a driving mode sensor, a pedal opening sensor, a vehicle speed sensor, a signal processing controller, a signal processing amplifier, a sound storage device, and a sound transmitting device, including: detecting, by the engine speed sensor, a speed of an engine of the vehicle; detecting, by the microphone, noise of the vehicle; detecting, by the engine state sensor, an operating state of the engine; detecting, by the driving mode sensor, a driving mode of the vehicle; detecting, by the pedal opening sensor, a pedal opening state of the vehicle; detecting, by the vehicle speed sensor, a speed of the vehicle; receiving, by the signal processing controller, the speed of the engine from the engine speed sensor, the noise of the vehicle from the microphone, and the engine operating state from the engine state sensor to generate amplified noise based on at least one of the received engine speed, the received noise of the vehicle, and the received engine operating state; receiving, by the signal processing amplifier, the speed of the engine from the engine speed sensor, the pedal opening state from the pedal opening sensor, the driving mode from the driving mode sensor, the speed of the vehicle speed from the vehicle speed sensor, and the amplified noise from the signal processing controller to generate output noise by amplifying the amplified noise as much as amplification degree based on at least one of the speed of the engine, the pedal opening state, the driving mode, and the speed of the vehicle; receiving, by the sound storage device, the output noise from the signal processing amplifier to determine a separate sound source corresponding to the output noise; and receiving, by the sound transmitting device, the separate sound source so that the sound transmitting device transmits the separate sound source to at least one of inside of an engine compartment of the vehicle, internal to the vehicle, and outside of the vehicle.

The sound storage device may be configured to determine the sound source corresponding to the output noise based on predetermined mapping data.

The system and the method for controlling noise of the vehicle according to the exemplary embodiment of the present invention may provide lively and quiet driving of the vehicle to a driver of the vehicle by controlling the noise within the vehicle in real time based on the operating state of the engine.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating a system of controlling noise of a vehicle according to an exemplary embodiment of the present invention.

FIG. 2 is a flowchart illustrating a method of controlling the noise of the vehicle according to an exemplary embodiment of the present invention.

FIG. 3 is a graph illustrating effect of an exemplary embodiment of the present invention.

FIG. 4 is a graph illustrating effect of an exemplary embodiment of the present invention.

FIG. 5 is a block diagram illustrating a system of controlling the noise of the vehicle according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Throughout the exemplary embodiment, unless explicitly described to the contrary, the word “comprise” and variations such as “comprises” or “comprising” will be understood to imply the inclusion of stated elements but not the exclusion of any other elements.

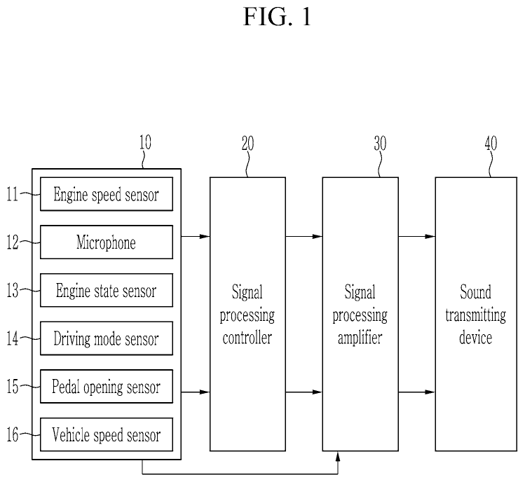

FIG. 1 is a block diagram illustrating a system or a device configured for controlling noise of a vehicle according to an exemplary embodiment of the present invention.

Referring to FIG. 1, the system for controlling the noise of the vehicle includes a data detector 10, a signal processing controller 20, a signal processing amplifier 30, and a sound transmitting device 40.

The data detector 10 detects data necessary for controlling noise of the vehicle, and transmits the data to the signal processing controller 20 and the signal processing amplifier 30. The data detector 10 includes an engine speed sensor 11, a microphone 12, an engine state sensor 13, a driving mode sensor 14, a pedal opening sensor 15, and a vehicle speed sensor 16.

The engine speed sensor 11 detects speed of an engine of the vehicle, and transmits the engine speed to the signal processing controller 20 and the signal processing amplifier 30.

The microphone 12 detects noise of the vehicle, and transmits the noise to the signal processing controller 20. The microphone 12 may be disposed in at least one of inside of an engine compartment of the vehicle, internal to the vehicle, and outside of the vehicle.

The engine state sensor 13 detects an operating state of the engine of the vehicle such as the engine vibration, the engine acceleration, the engine combustion pressure, and transmits the operating state to the signal processing controller 20. The engine state sensor 13 may include a vibration sensor, a combustion pressure sensor, and an acceleration sensor. However, the present invention is not limited thereto and may include all kind of sensors that detect the operating state.

The driving mode sensor 14 detects a driving mode and a gear stage of the vehicle, and transmits the driving mode and the gear stage to the signal processing amplifier 30.

The pedal opening sensor 15 detects a pedal opening state or a pedal opening amount of the vehicle, and transmits the pedal opening state to the signal processing amplifier 30.

The pedal opening state may include an opening amount of an acceleration pedal of the vehicle, a change in the acceleration pedal opening amount, or real-time location of the acceleration pedal, but the present invention is not limited thereto.

The vehicle speed sensor 16 detects speed of the vehicle, and transmits the vehicle speed to the signal processing amplifier 30.

The engine speed sensor 11, the driving mode sensor 14, the pedal opening sensor 15, and vehicle speed sensor 16 may transmit and receive data detected by the sensors using a control area network (CAN), but the present invention is not limited thereto.

The signal processing controller 20 receives the speed of the engine from the engine speed sensor 11, the noise of the vehicle from the microphone 12, and the engine operating state from the engine state sensor 13.

The signal processing controller 20 may generate at least one of reinforced noise and reduced noise based on at least one of the speed of the engine, the noise of the vehicle, and the operating state of the engine.

The signal processing controller 20 generates amplified noise which may include at least one of the reinforced noise and the reduced noise, and transmits the amplified noise to the signal processing amplifier 30.

The reinforced noise may be noise required to improve a driver's sense of acceleration when the driver of the vehicle accelerates the vehicle among the engine noise and the reduced noise may be noise required to provide quietness internal to the vehicle when the driver drives the vehicle.

The signal processing controller 20 may be a proportional-integral-differential (PID) controller but is not limited thereto.

The signal processing controller 20 may be realized by one or more processors activated by a predetermined program. The predetermined program may be programmed to perform each step for generating the amplified noise according to an exemplary embodiment of the present invention.

The signal processing amplifier 30 receives the speed of the engine from the engine speed sensor 11 and the amplified noise from the signal processing controller 20.

The signal processing amplifier 30 generates output noise by amplifying the amplified noise as much as an amplification degree based on the speed of the engine, and transmits the amplified noise to the sound transmitting device 40.

When the signal processing amplifier 30 sets the amplification degree, at least one of the driving mode of the vehicle received from the driving mode sensor 14, the pedal opening state received from the pedal opening sensor 15, and the speed of the vehicle received from the vehicle speed sensor 16 may be further considered.

The signal processing amplifier 30 may be a proportional-integral-differential (PID) controller but is not limited thereto.

The signal processing amplifier 30 may be realized by one or more processors activated by a predetermined program, and the predetermined program may be programmed to perform each step for generating the output noise according to an exemplary embodiment of the present invention.

The sound transmitting device 40 receives the output noise from the signal processing amplifier 30 and transmits the output noise to the vehicle. The output noise may be output in at least one of inside of the engine compartment, internal to the vehicle, and outside of the vehicle but is not limited thereto.

The sound transmitting device 40 may be a speaker but is not limited there to. The speaker may be replaced by a component that performs a same function as that of the speaker according to a designer's intention.

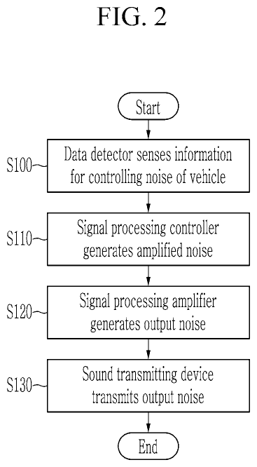

FIG. 2 is a flowchart illustrating a method of controlling the noise of the vehicle according to an exemplary embodiment of the present invention.

The data detector 10 detects information for controlling noise of the vehicle and transmits the information to the signal processing controller 20 and the signal processing amplifier 30 (step S100).

The data detector 10 may include the engine speed sensor 11, the microphone 12, the engine state sensor 13, the driving mode sensor 14, the pedal opening sensor 15, and the vehicle speed sensor 16.

The engine speed sensor 11 detects the engine speed of the vehicle, and transmits the engine speed to the signal processing controller 20 and the signal processing amplifier 30.

The microphone 12 detects noise in at least one of inside of the vehicle and the engine compartment of the vehicle and transmits the noise to the signal processing controller 20.

The engine state sensor 13 detects the engine operating state of the vehicle and transmits the engine operating state to the signal processing controller 20. For example, the engine state sensor 13 may include the vibration sensor and the acceleration sensor.

The vibration sensor may detect the engine vibration and may transmit the engine vibration to the signal processing controller 20.

The acceleration sensor may detect the engine acceleration and may transmit the engine acceleration to the signal processing controller 20.

The driving mode sensor 14 detects driving mode of the vehicle and transmits the driving mode to the signal processing amplifier 30.

The pedal opening sensor 15 detects the pedal opening state, and transmits the pedal opening state to the signal processing amplifier 30.

The vehicle speed sensor 16 detects speed of the vehicle and transmits the speed of the vehicle to the signal processing amplifier 30.

The signal processing controller 20 generates the amplified noise considering at least one of the information received from data detector 10, and transmits the amplified noise to the signal processing amplifier 30 (step S110).

In other words, the signal processing controller 20 may generates the amplified noise based on at least one of the engine speed received from the engine speed sensor 11 and the engine operating state received from the engine state sensor 13.

In more detail, the signal processing controller 20 determines the engine frequency based on the engine speed received from the engine speed sensor 11.

Determining of the engine frequency is based on a following equation 1

$$engine frequency = engine speed \times \frac{1}{60 sec} \times \frac{2}{number of cycle} \times number of cylinder \qquad ( Equation 1 )$$

The signal processing controller 20 analyzes vibration frequency characteristic of the engine and sets an engine order component, based on at least one of the engine frequency and the engine operating state received from the engine state sensor 13. The engine order component frequency may be expressed as a following equation 2

$$N - degree engine order compnent frequency = \frac{engine frequency}{N} \qquad ( Equation 2 )$$

The N means that vibration excitation force is generated at N rotation speed based on crankshaft rotation number of the engine. The engine order component corresponding to the N-degree engine order component frequency band is referred to as the N-degree engine order component. For example, first engine order frequency may be same with the engine frequency and may be referred as primary engine order component, and second engine order frequency may be same with the engine frequency/2 and may be referred as secondary engine order component.

A Fast Fourier Transform (FFT) may be used to analyze the engine vibration frequency characteristic. A method for analyzing the engine vibration frequency characteristic using the FFT is obvious to a person skilled in the art, and therefore detailed descriptions thereof will be omitted.

The signal processing controller 20 extracts an engine order component necessary to implement target noise from the engine vibration frequency characteristic. The target noise may be noise by which the driver feels an acceleration feeling when the driver accelerates the vehicle. The noise may be an arbitrary value selected by a person skilled in the art.

The engine order component to implement the target noise may be a main engine order component. The main engine order component is the engine order component corresponding to one half of the engine cylinder number and the engine order component corresponding to the engine cylinder number of the engine. For example, in the case of a four-cylinder engine, the secondary engine order component and a fourth engine order component may be the main engine order component.

The signal processing controller 20 implements the target noise by arranging the extracted engine order components and generates the reinforced noise by amplifying the target noise.

In other words, the signal processing controller 20 generates the reinforced noise by amplifying the target noise as much as amplification degree.

The amplification degree of the target noise may be an arbitrary value selected by a person skilled in the art.

The signal processing controller 20 may generate the reduced noise based on at least one of noise received from the microphone 12 and the engine order component.

The reduced noise may be noise with a phase opposite to that of the vehicle internal noise received from the microphone 12 or noise having an opposite phase to that of noise of the engine compartment, and may be noise to remove a useless noise internal to vehicle.

The useless noise may be noise other than the reinforced noise among the noise internal to the vehicle, but is not limited thereto.

The signal processing controller 20 may consider the engine order component when the reduced noise is generated. The reduced noise may include noise which is reversed frequency of the engine order component that forms useless noise among the engine order component. The engine order component that forms useless noise among the engine order component may be a remaining engine order component other than the engine order component extracted for implementing the target noise when the reinforced noise is generated, but is not limited thereto.

In other words, the reduced noise may include at least one of the noise which is reversed phase of noise internal to the vehicle or noise in the engine compartment and the noise which is reversed frequency of the engine order component that forms useless noise among the engine order component.

The signal processing controller 20 generates the amplified noise by adding the reinforced noise and the reduced noise, and transmits the amplified noise to the signal processing amplifier 30.

The amplified noise may include at least one of the reinforced noise and the reduced noise.

The signal processing amplifier 30 generates the output noise by amplifying the amplified noise received from signal processing controller 20 (step S120).

The signal processing amplifier 30 sets amplification degree of the amplified noise based on the engine speed received from the engine speed sensor 11, and generates the output noise by amplifying the amplified noise as much as the amplification degree.

For example, when the engine speed is greater than a predetermined value, the signal processing amplifier 30 may determine that the driver accelerates the vehicle so that the signal processing amplifier increases the amplification degree. The predetermined value is an arbitrary value selected by person skilled in the art.

The signal processing amplifier 30 may set the amplification degree by considering the pedal opening state received from the pedal opening sensor 15.

For example, when a change in the pedal opening amount is greater than a predetermined value or the pedal opening amount is greater than a predetermined value, the signal processing amplifier 30 may determine that the driver accelerates the vehicle to increase the amplification degree.

The predetermined value is an arbitrary value selected by those skilled in the art. The signal processing amplifier 30 may set the amplification degree by considering speed of the vehicle received from the vehicle speed sensor 16.

For example, when the signal processing amplifier 30 determines that the driver drives the vehicle at constant speed, the amplification degree of the amplified noise may be reduced, and when the signal processing amplifier 30 determines that the driver accelerates the vehicle, the amplification degree of the amplified noise may be increased.

The signal processing amplifier 30 differentiates a change in the speed of the vehicle and may determine that the driver operates the vehicle at constant speed when the differential value is less than and equal to a predetermined value. The signal processing amplifier 30 may determine that the driver accelerates the vehicle when the differential value is greater than the predetermined value. The predetermined value is an arbitrary value selected by person skilled in the art.

The signal processing amplifier 30 may set the amplification degree by considering the driving mode received from the driving mode sensor 16. The driving mode of the vehicle may be one of a fuel economy mode, a normal mode, and a sports mode, but is not limited thereto.

The fuel economy mode is a mode for realizing high fuel efficiency, and means a mode in which the engine speed at which shifting of the vehicle is performed is lower than that of the normal mode. The sports mode is a mode for improving acceleration performance of the vehicle, and is a driving mode in which the vehicle utilizes a high engine speed. The normal mode is a driving mode of vehicle that does not include the fuel economy mode and the sports mode.

For example, the amplification degree of the amplified noise may be set to be small when the driver drives the vehicle in the fuel economy mode in which a change in the engine revolutions per minute (RPM) is small. When the driver drives the vehicle in the sports mode in which the engine RPM change is great, the amplification degree of the amplified noise may be set great.

The signal processing amplifier 30 may select an engine order component that requires amplifying among the engine order components forming the amplified noise based on the driving mode of the vehicle.

The signal processing amplifier 30 may set the amplification degree of the amplified noise by setting an amplification degree of the selected engine order component. The engine order component and the amplification degree may be arbitrary values selected by those skilled in the art.

The signal processing amplifier 30 generates the output noise by amplifying the amplified noise and transmits the output noise to the sound transmitting device 40.

The sound transmitting device 40 transmits the output noise received from the signal processing amplifier 30 to the vehicle (step S130).

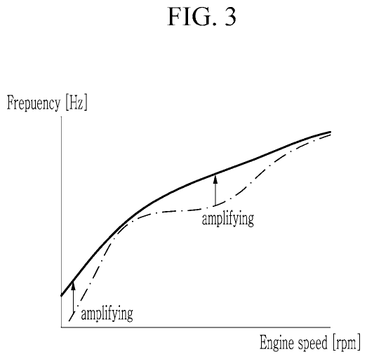

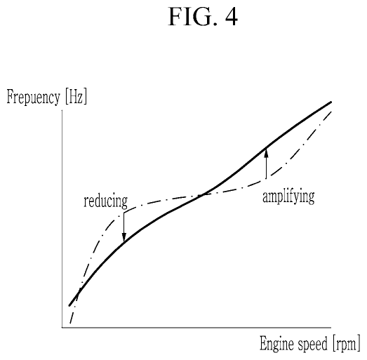

The sound transmitting device 40 may output the output noise received from the signal processing amplifier 30 to at least one of the engine compartment, internal to the vehicle, and outside of the vehicle. Accordingly, the sound transmitting device 40 may provide a quiet driving for the vehicle when the driver drives the vehicle or may provide the driver's detect of acceleration to the driver when the driver accelerates the vehicle. FIG. 3 and FIG. 4 are graphs illustrating effect of an exemplary embodiment of the present invention.

FIG. 3 is a graph illustrating noise internal to the vehicle when the output noise is constituted with only the amplified noise.

The sound transmitting device 40 may amplify the engine order component forming the target noise by outputting the output noise. Therefore, the driver may sense acceleration feeling when the driver accelerates the vehicle.

FIG. 4 is a graph illustrating noise internal to the vehicle when the output noise includes the amplified noise and the reduced noise.

The sound transmitting device 40 may amplify the engine order component forming the target noise and may remove a useless noise internal to the vehicle by outputting the output noise.

Therefore, it is possible to provide the driver with a quiet driving when the driver drives the vehicle and a feeling of acceleration when the driver accelerates the vehicle.

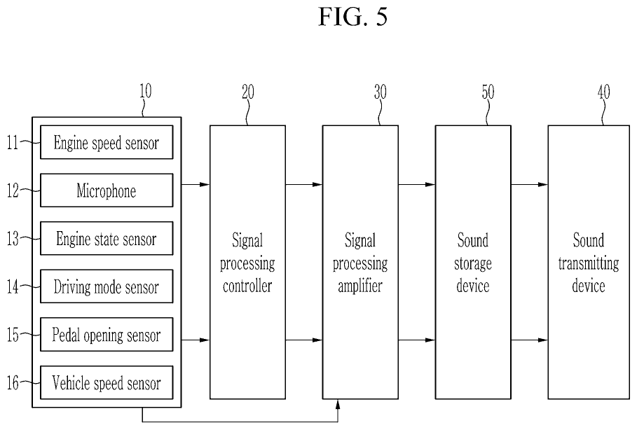

FIG. 5 is a block diagram illustrating a system for controlling the noise of the vehicle according to various exemplary embodiments of the present invention.

Except for some components, the system for controlling the noise of the vehicle is same with the system for controlling the noise of the vehicle illustrated in FIG. 1. Therefore, a detailed description of the components illustrated in FIG. 5 which are same with the components illustrated in FIG. 1 will be omitted.

As shown in FIG. 5, the system for controlling the noise of the vehicle includes the data detector 10, the signal processing controller 20, the signal processing amplifier 30, the sound transmitting device 40, and a sound storage device 50.

The data detector 10 includes the engine speed sensor 11, the microphone 12, the engine state sensor 13, the driving mode sensor 14, the pedal opening sensor 15, and the vehicle speed sensor 16. A separate sound source corresponding to the amplified noise is stored in the sound storage device 50.

The sound storage device 50 selects the separate sound source corresponding to the amplified noise according to preset mapping data, and transmits the selected separate sound source to the sound transmitting device 40.

Hereinafter, a method for controlling the noise of the vehicle by the vehicle noise control system will be described.

The data detector 10 detects information for controlling the noise of the vehicle and transmits the information to the signal processing controller 20 and the signal processing amplifier 30.

The signal processing controller 20 generates the amplified noise based on at least one of the engine speed received from the engine speed sensor 11, the noise of the vehicle received from the microphone 12, and the engine operating state of the vehicle received from the engine state sensor 13, and transmits the amplified noise to the signal processing amplifier 30.

The signal processing amplifier 30 generates the output noise by amplifying the amplified noise as much as the amplification degree based on the speed of the engine, and transmits the amplified noise to a sound storage device 50.

When the signal processing amplifier 30 sets the amplification degree, at least one of the driving mode of the vehicle received from the driving mode sensor 14, the pedal opening state received from the pedal opening sensor 15, and the speed of the vehicle received from the vehicle speed sensor 16 may be considered.

The sound storage device 50 selects the separate sound corresponding to the amplified noise, and transmits the separate sound to the sound transmitting device 40.

The sound transmitting device 40 receives the separate sound from sound storage device 50, and transmits the separate sound to the vehicle.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A system for controlling noise of a vehicle, the system comprising:
an engine speed sensor configured to detect a speed of an engine of the vehicle;
a microphone configured to detect the noise of the vehicle;
an engine state sensor configured to detect an operating state of the engine;
a signal processing controller connected to the engine speed sensor, the microphone and the engine state sensor and configured to receive the speed of the engine from the engine speed sensor, the noise of the vehicle from the microphone, and the operating state of the engine from the engine state sensor and to generate amplified noise based on at least one of the speed of the engine, the noise of the vehicle, and the operating state of the engine;
a signal processing amplifier connected to the engine speed sensor and the signal processing controller and configured to receive the speed of the engine from the engine speed sensor and the amplified noise from the signal processing controller and to generate output noise by amplifying the amplified noise as much as amplification degree based on the speed of the engine; and
a sound transmitting device connected to the signal processing amplifier and configured to receive the output noise and transmit the output noise or a separate sound source corresponding to the output noise to the vehicle.

2. The system of claim 1, wherein the microphone is mounted in at least one of inside of an engine compartment of the vehicle, internal to the vehicle, and outside of the vehicle.

3. The system of claim 1, wherein the sound transmitting device is mounted in at least one of inside of an engine compartment of the vehicle, internal to the vehicle, and outside of the vehicle.

4. The system of claim 1,
wherein the amplified noise includes at least one of reinforced noise and reduced noise, and
wherein the signal processing controller is configured to generate the reinforced noise based on at least one of the speed of the engine and the operating state of the engine.

5. The system of claim 4, wherein the signal processing controller is configured to generate the reduced noise based on at least one of the noise of the vehicle received from the microphone and an engine order component corresponding to a frequency characteristic of the engine.

6. The system of claim 1, further including:
a pedal opening sensor configured to detect a pedal opening state of the vehicle and transmit the pedal opening state to the signal processing amplifier,
wherein the signal processing amplifier is configured to set the amplification degree based on the pedal opening state received from the pedal opening sensor.

7. The system of claim 1, further including:
a driving mode sensor configured to detect a driving mode of the vehicle and transmit the driving mode to the signal processing amplifier,
wherein the signal processing amplifier is configured to set the amplification degree based on the driving mode.

8. The system of claim 1, further including:
a vehicle speed sensor configured to detect a speed of the vehicle and transmit the speed of the vehicle to the signal processing amplifier,
wherein the signal processing amplifier is configured to set the amplification degree based on the speed of the vehicle.

9. The system of claim 1, further including:
a sound storage device connected to the signal processing amplifier and the sound transmitting device and configured to receive the output noise and determine the separate sound source corresponding to the output noise to transmit the separate sound source to the sound transmitting device.

10. The system of claim 9, wherein the sound storage device is configured to determine the separate sound source corresponding to the output noise based on predetermined mapping data to transmit the separate sound source to the sound transmitting device.

11. A method for controlling noise of a vehicle including an engine speed sensor, a microphone, an engine state sensor, a signal processing controller, a signal processing amplifier, and a sound transmitting device, the method comprising:
detecting, by the engine speed sensor, a speed of an engine of the vehicle;
detecting, by the microphone, the noise of the vehicle;
detecting, by the engine state sensor, an operating state of the engine;
receiving, by the signal processing controller, the speed of the engine from the engine speed sensor, the noise of the vehicle from the microphone, and the operating state of the engine from the engine state sensor to generate amplified noise based on at least one of the speed of the engine, the noise of the vehicle, and the operating state of the engine;
receiving, by the signal processing amplifier, the speed of the engine from the engine speed sensor and the amplified noise from the signal processing controller to generate output noise by amplifying the amplified noise as much as amplification degree based on the speed of the engine; and
receiving, by the sound transmitting device, the output noise from the signal processing amplifier so that the sound transmitting device transmits the output noise to the vehicle.

12. The method of claim 11, wherein the noise of the vehicle is detected in at least one of inside of an engine compartment of the vehicle, internal to the vehicle, and outside of the vehicle.

13. The method of claim 11, wherein the output noise is transmitted to at least one of an engine compartment of the vehicle, internal to the vehicle, and outside of the vehicle.

14. The method of claim 11,
wherein the amplified noise includes at least one of reinforced noise and reduced noise, and
wherein the reinforced noise is generated based on at least one of the speed of the engine and the operating state of the engine.

15. The method of claim 14, wherein the reduced noise is generated based on at least one of the noise of the vehicle received from the microphone and an engine order component corresponding to a frequency characteristic of the engine.

16. The method of claim 11,
wherein the vehicle further includes a pedal opening sensor configured to detect a pedal opening state of the vehicle, and transmit the pedal opening state to the signal processing amplifier, and
wherein the signal processing amplifier is configured to set the amplification degree based on the pedal opening state received from the pedal opening sensor.

17. The method of claim 11,
wherein the vehicle further includes a driving mode sensor configured to detect a driving mode of the vehicle and transmit the driving mode to the signal processing amplifier, and
wherein the signal processing amplifier is configured to set the amplification degree based on the driving mode.

18. The method of claim 11,
wherein the vehicle further includes a vehicle speed sensor configured to detect a speed of the vehicle and transmit the speed of the vehicle to the signal processing amplifier, and
wherein the signal processing amplifier is configured to set the amplification degree based on the speed of the vehicle.

19. A method for controlling noise of a vehicle including an engine speed sensor, a microphone, an engine state sensor, a driving mode sensor, a pedal opening sensor, a vehicle speed sensor, a signal processing controller, a signal processing amplifier, a sound storage device, and a sound transmitting device, the method comprising:
detecting, by the engine speed sensor, a speed of an engine of the vehicle;
detecting, by the microphone, the noise of the vehicle;
detecting, by the engine state sensor, an operating state of the engine;
detecting, by the driving mode sensor, a driving mode of the vehicle;
detecting, by the pedal opening sensor, a pedal opening state of the vehicle;
detecting, by the vehicle speed sensor, a speed of the vehicle;
receiving, by the signal processing controller, the speed of the engine from the engine speed sensor, the noise of the vehicle from the microphone, and the operating state of the engine from the engine state sensor to generate amplified noise based on at least one of the speed of the engine, the noise of the vehicle, and the operating state of the engine;
receiving, by the signal processing amplifier, the speed of the engine from the engine speed sensor, the pedal opening state from the pedal opening sensor, the driving mode from the driving mode sensor, the speed of the vehicle speed from the vehicle speed sensor, and the amplified noise from the signal processing controller to generate output noise by amplifying the amplified noise as much as amplification degree based on at least one of the speed of the engine, the pedal opening state, the driving mode, and the speed of the vehicle;
receiving, by the sound storage device, the output noise from the signal processing amplifier to determine a separate sound source corresponding to the output noise; and
receiving, by the sound transmitting device, the separate sound source so that the sound transmitting device transmits the separate sound source to at least one of inside of an engine compartment of the vehicle, internal to the vehicle, and outside of the vehicle.

20. The method of claim 19, wherein the sound storage device is configured to determine the separate sound source corresponding to the output noise based on predetermined mapping data.
